(19) United States
(12) Patent Application Publication
(10) Pub. No.: US 2013/0294199 A1
(43) Pub. Date: Nov. 7, 2013

(54) Method And Device For Estimating The Content Of A Solid Material Container

(71) Applicants: Israel Polishuk, Gan Yavne (IL); Raanan Ben Sinai, Modi'in (IL); Amnon Polishuk, Shoham (IL); Anat Tehila Kliger, Tel Aviv (IL)

(72) Inventors: Israel Polishuk, Gan Yavne (IL); Raanan Ben Sinai, Modi'in (IL); Amnon Polishuk, Shoham (IL); Anat Tehila Kliger, Tel Aviv (IL)

(21) Appl. No.: 13/980,797

(22) PCT Filed: Jan. 12, 2012
(86) PCT No.: PCT/IL12/00024

§ 371 Date: Jul. 19, 2013

(30) Foreign Application Priority Data
Jan. 20, 2011 (IL) 210776

(51) Int. Cl. G01F 23/296

(52) U.S. Cl. CPC G01F 23/2966
USPC 367/118

(57) ABSTRACT

The invention relates to a method for estimating the contents of particulate solids in a solid container, comprising the steps of: a) providing a percussion device; b) hitting the surface of the container on it outside with said percussion device at predetermined distances along the height of the container; c) recording the sound created by said percussion; d) identifying the sound generated by each recorded percussion at the percussion time within a plurality of percussions; e) applying a analysis algorithm to a digital representation of the sounds identified in d above; and e) determining the heights of the container that is filled with particulate material by locating the height at which the value resulting from the analysis of each percussion changes from a high to lower value, wherein a higher value indicates an empty portion of the container, and a lower value indicates a filled portion of the container.

### FIELD OF THE INVENTION

The present invention relates to the field of measurement. More particularly, the invention relates to a method for estimating the amount of particulate solid material contained in a container.

### BACKGROUND OF THE INVENTION

Solid materials in particulate form are typically kept in vertical containers of the silo type. Such particulate materials are of very different types, such as vegetable grain and construction material, such as cement. The particulate materials to which invention is directed have physical properties, such as density, particle size distribution, stickiness, etc. which may differ by orders of magnitude from one another, e.g., when comparing agriculture materials with construction materials. Nevertheless, all silos and old materials contained therein present a common problem, i.e., it is both extremely important and very difficult to estimate the amount of material left in the silo after amounts have been withdrawn from it.

One of the factors that render such measurement—or even estimate—extremely difficult is that the material that is funneled through the silo builds “walls” along the inner walls of the silo, i.e., a layer of material sloping down toward the level of the completely filled portion of the silo. Depending on particle properties such amounts may be significant and their presence on the walls adversely affect attempts at measurement.

The art has so far failed to address this problem in an efficient manner. JP56089021A2 relates to an acoustic level measuring method, which involves measuring the level of the contents of a storage tank by generating an impulsive sound by applying shock to the external wall of the storage tank and then by electrically detecting an echo sound changing according to level of the contents. The sound so generated is supposed to provide an indication of the level (or height) of the material in the silo, which by simple geometrical calculation yields the volume of material contained therein. Similarly, U.S. Pat. No. 4,535,628 relates to a level measurement apparatus for material in container, which determines acoustic transmission value and compares with known characteristics for vessel and medium. A similar arrangement is provided in DE 10009019.

While the general principle described in the art has logical basis, the practical result is that measurements carried out according to the teaching of the prior art provide erratic and unrepeatable results, because of the variable behavior of particulate materials under different conditions, as explained briefly above. It is therefore clear that it would be highly desirable to provide means for generating a precise estimate of the contents of a silo.

It is an object of the present invention to provide a method for generating an accurate estimate of the contents of particulate solid held in a silo.

It is another object of the invention to provide a device by which the method can be efficiently carried out.

It is yet another object of the invention to provide a means by which up to date information on the conference of the silo and be provided to and interested party.

Other advantages and objects of the invention will become apparent as the description proceeds.

### SUMMARY OF THE INVENTION

The invention relates to a method for estimating the contents of particulate solids in a solid container, comprising the steps of:
a. providing a percussion device;
b. hitting the surface of the container on it outside with said percussion device at predetermined distances along the height of the container;
c. recording the sound created by said percussion;
d. identifying the sound generated by each recorded percussion at the percussion time within a plurality of percussions;
e. applying a analysis algorithm to a digital representation of the sounds identified in d above; and
f. determining the heights of the container that is filled with particulate material by locating the height at which the value resulting from the analysis of each percussion changes from a high to lower value, wherein a higher value indicates an empty portion of the container, and a lower value indicates a filled portion of the container.

According to an embodiment of the present invention, the hitting is done by a precise lifting and dropping the percussion device, such that the extent of the impact is constant every time, which makes it possible to effectively analyze the shock wave generated.

According to an embodiment of the present invention, the estimated contents of a container or of a plurality of containers can be reported in real time (near real time).

According to an embodiment of the present invention, the identifying of the sound is done by a peak detection algorithm, which operates on the raw data of the recorded sound.

According to an embodiment of the present invention, the analysis algorithm is a Kurtosis-like algorithm. According to another embodiment of the present invention, the analysis algorithm is based on resonance energy calculations.

In another aspect the invention relates to a device for generating an indication of an estimate of the measure of feeling of a container of particulate solids, comprising:
a. a percussion assembly suitable to generate a shockwave by hitting the outer surface of said container at different heights;
b. a sound recorder;
c. an analog to digital device to digitize the sounds recorded by said recorder;
d. logic circuitry to analyze said sounds and to generate an estimate of the height of the particulate material within the container; and
e. cellular module, coupled to said circuitry, which is suitable to transmit a value representative of said estimate to a remote location.

### BRIEF DESCRIPTION OF THE DRAWINGS

In the drawings:

FIG. 1 schematically illustrates a shockwave-generating device according to one embodiment of the invention;

FIG. 2 is a front view of the device of FIG. 1;

FIG. 3 shows the results of the experiment of Example 1. In all figures the black bars indicate a response relative to a full portion of a container, and the empty bars indicate a response relative to an empty portion of a container;

FIG. 4 shows the results of the experiment of Example 2;

FIGS. 5 and 6 illustrate results obtained according to the invention;

FIG. 7 is a schematic description of the development of an “if-then” rules set and its use;

FIGS. 8 through 10 further illustrate elements of a practical design of the device schematically shown in FIGS. 1 and 2;

FIG. 11 illustrates a vector of sampling of length of about tenth a second (0.1 sec) starting at the index time, which represents the recording of the percussion;

FIG. 12 illustrates an example of vector K as obtained while applying resonance calculations, according to some embodiments of the present invention; and

FIG. 13 shows an example of the resonance vector K for a specific recording.

### DETAILED DESCRIPTION OF THE INVENTION

Throughout this description the term “silo” is used to indicate an essentially vertical container adapted to hold particulate solid material. This term does not imply any particular shape, construction material or geometry, and invention is applicable to all suitable particulate solid containers.

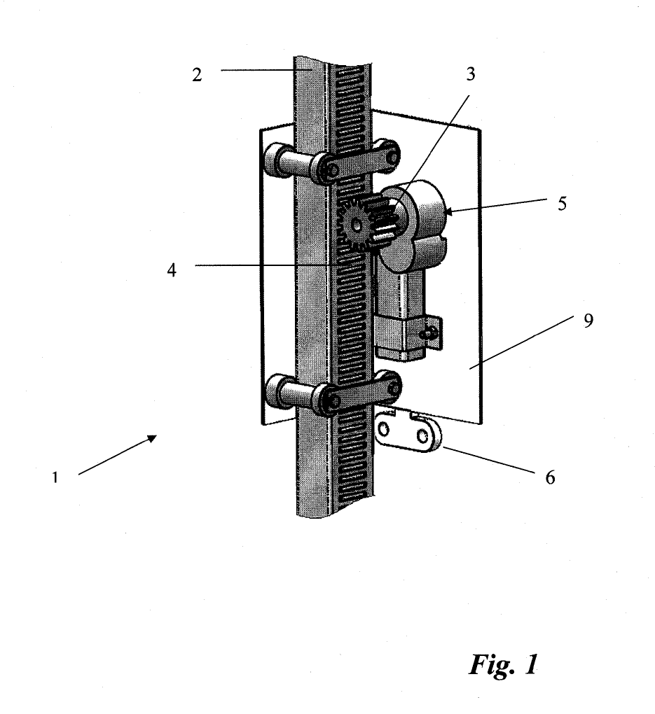

FIG. 1 shows a device that can be used in conjunction with the invention. The device illustrated in this figure is particularly convenient because it can be applied as an ad-on device to existing silos without the need to carry out major alterations in the structure. The device generally indicated by numeral 1 in the figure comprises a rail 2, which extends along a major portion of the height of the silo and only a small portion of which is shown in the figure. The rail is coupled in this embodiment of the invention with a pinion 3 which advances in a regular manner incorporation with notches 4 in rail 2. Pinion 3 is coupled with a shock-generating mechanism 5, to be discussed in greater details below, which in turn is coupled with a knocking element, the percussion head 6 of which is seen in the figure.

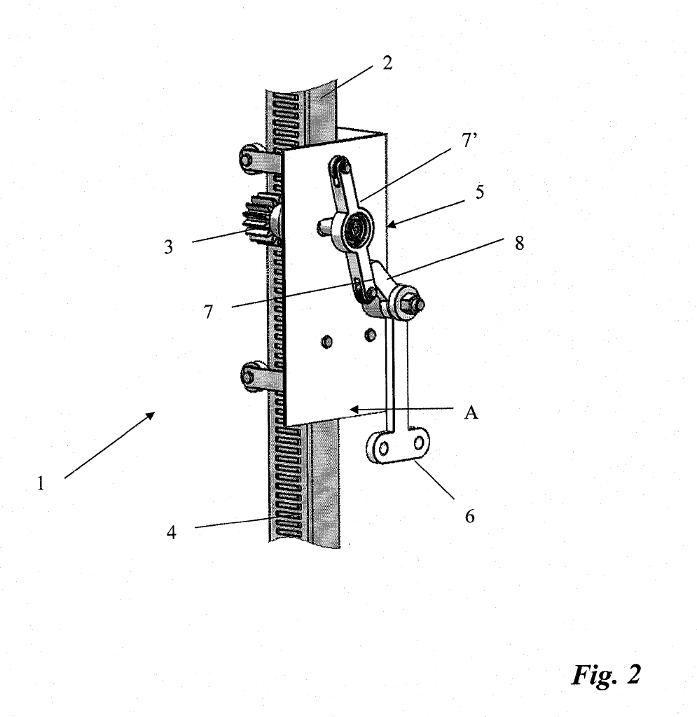

FIG. 2 is a front view of the device of FIG. 1, in which the moving portion of knocking mechanism 5 is seen as consisting of two levers, 7 and 7′, which rotate when the pinion 3 moves along rail 2, such that it pushes portion 8 of the knocking mechanism, closing percussion head 6 to be lifted in the direction of arrow A. When pinion 3 turns further the grip of lever 7 on portion 8 is lost and percussion head 6 falls, hits the surface of the silo and thus generates a shockwave and a sound, which is recorded by recording means that are part of the device.

As will be appreciated by the skilled person the arrangement described in the figures results in a precise lift and drop of percussion head 6, such that the extent of the impact is constant every time, which makes it possible to effectively analyze the shock wave generated. This process (i.e., the lifting and dropping of percussion head 6) happens at fixed intervals, which can be preset in the device by selecting the appropriate geometrical proportions between the pinion, rail and levers, as well as their relative location on the device, since they can be positioned differently relative to supporting plate 9.

An additional advantage provided by the invention is the real time (or, if preferred, near real time) reporting of the estimated contents of a silo or of a plurality of silos. This is important in many cases inasmuch as a plurality of silos service many clients who withdraw material from them, and of course some such silos are located at faraway locations, rendering it difficult for the owners to determine when they should be refilled and what amounts are still available for service. According to the invention a cellular module is coupled (whether physically or remotely) to the logical circuits employed to estimate the particulate solid content (to be discussed in detail below), and transmit the results of such estimate for a given silo to a remote location where it is received and used. This arrangement obviates many disadvantages of existing silo farms.

Turning now to the logical circuit, it is composed of audio receiving apparatus suitable to record the sound generated by the percussion of percussion head 6 of FIGS. 1 and 2 on the silo's surface, which is coupled to A2D circuitry and to logical circuitry that carries out the analysis to be described below.

Turning now to the logical circuit, the audio signal is acquired through a microphone and a coupled codec which contains an A/D converter. It is sent to the DSP and stored in its memory. It is in the DSP that the entire analysis to be described below is performed. Once the DSP finished its calculations, and has a result/decision about the amount of particulate solid material contained in the silo, a message is sent to a specified cell-phone via a GSM module that is also connected to the DSP.

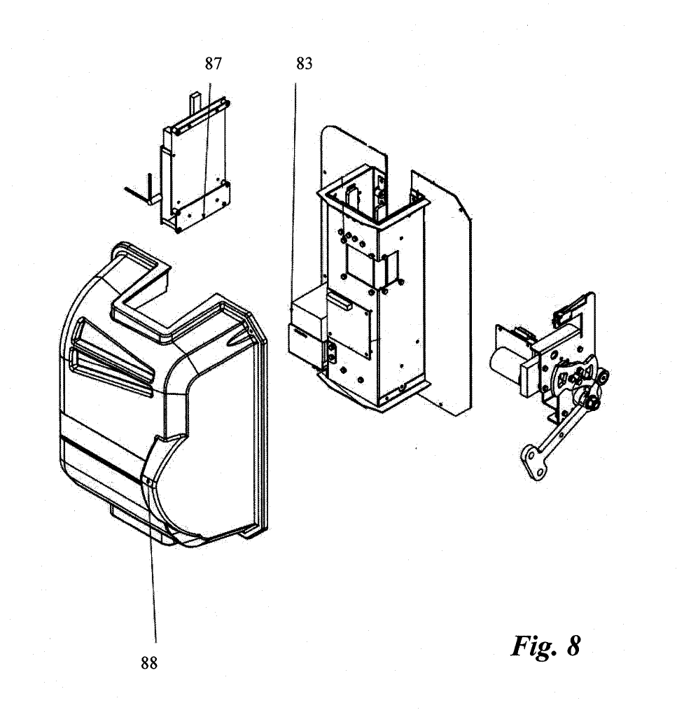

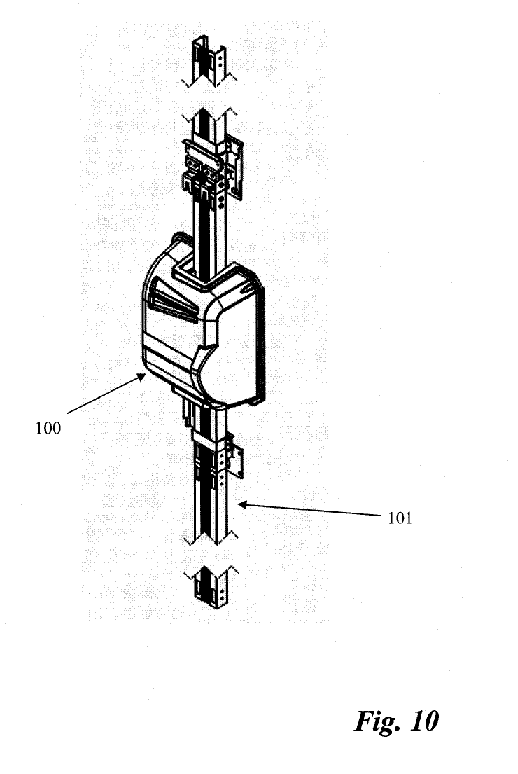

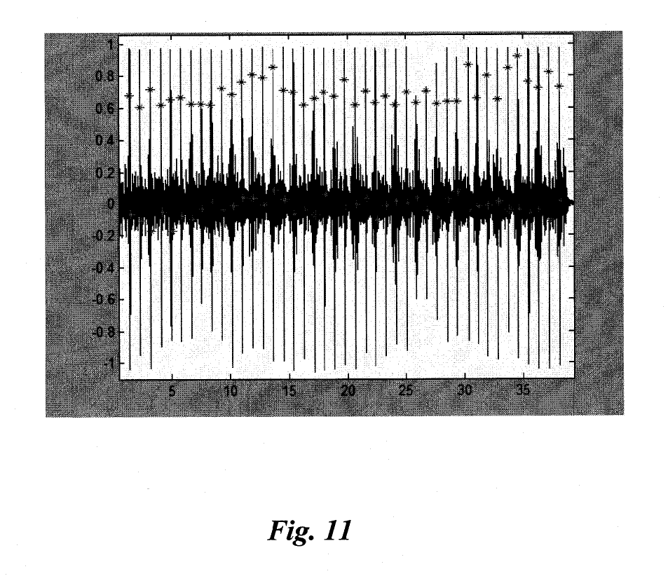

FIGS. 8-10 illustrate some elements of an actual device according to one embodiment of the invention. In FIG. 8, numeral 83 is a battery used to operate the device when it is used as a stand-alone apparatus, i.e., when no electrical mains is available. The battery can be replaced periodically, or may be rechargeable, e.g., by solar energy. Numeral 87 is a housing that contains electronic components and 88 is the cover that protects the internal parts. FIG. 10 shows a device 100 according to the invention, in assembled state on the rail 101 that is attached to a container (not shown).

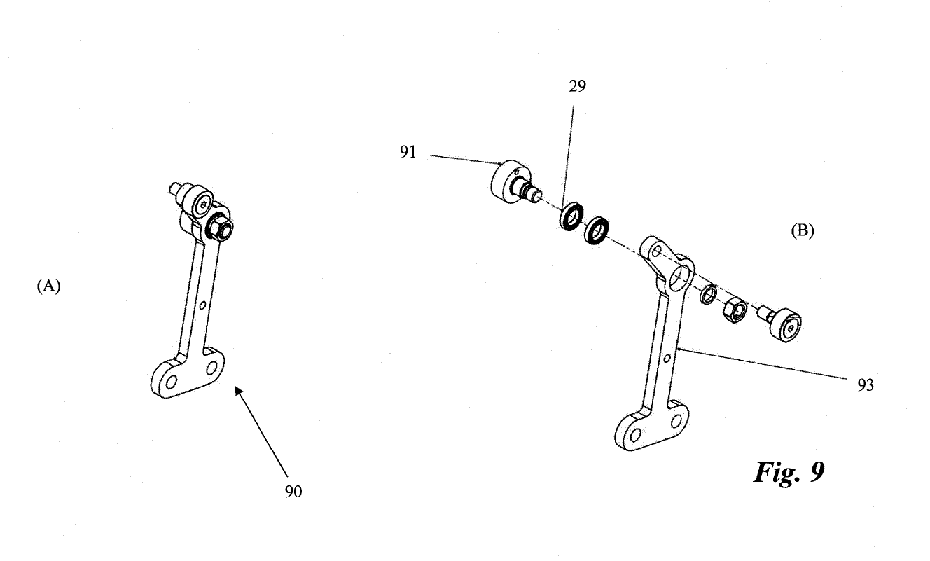

FIG. 9 shows the hammer 90 in its assembled state (FIG. 9 A), as well as an exploded view thereof (FIG. 9 B), which shows the hammer axis 91, a ball bearing 92 and the hammer body, 93.

All the above will be better understood through the following illustrative and non-limitative examples.

### Example 1

The silo employed in the experiment was a pilots silo having the following characteristics:

Height of the straight portion: 305 cm.

Radius: 143.3 cm.

Height of the first percussion: 25 cm.

Distance between percussions: 14 cm.

Radius of the bottom portion of the funnel: 31.3 cm.

Height of the sloping portion of the funnel: 141 cm.

Two different algorithms, PeakDet and Modified PeakDet, were employed and for each algorithm to analysis algorithms, Energy and Kurtosis, were employed.

Both the first peak detection algorithm, denoted as PeakDet, and the second one denoted as Modified PeakDet, operate on the recorded raw data that was previously acquired. First, according to the number of knocks, M (which is known), and according to the time between knocks, T_{between-Knocks}, (measured earlier) we predict M hit locations. Then, a window of 600 msecs is created around each predicted hit location. Each window is then sent to the PeakDet algorithm in which we try to locate the exact time (index) of the knock/peak.

The PeakDet algorithm looks for the highest point between two lowest points (“valleys”). It looks for the highest point, around which there are points lower by some threshold (Delta) on both sides. Once the peak is detected, we continue directly to the next time interval and use the same PeakDeat algorithm to detect the next hit place.

The Modified PeakDet uses a similar algorithm but this time the predicted hit location (and the 600 msecs window) is dynamically modified according to the previously determined hit point.—for example, if the first hit was determined to be at 1.5 secs, the next hit place will now be predicted to be at 1.5 secs+T_{between-Knocks}. The next iteration of the peak detection algorithm will now be fed with the newly calculated next predicted hit place. According to this method, the information about the location of the adjacent previous hit, is taken into account and is used in order to dynamically change and predict the next hit place.

As will be further explained hereinafter the analysis made employing the Kurtosis algorithm (which is a well-known algorithm described, for instance in http://en.wikipedia.org/wiki/Kurtosis) yielded the best results and, therefore, this is one preferred method to carry out invention, although of course less precise results can be obtained using alternative algorithms and, furthermore, algorithms comparable to Kurtosis can be employed, all of which is encompassed by the invention. For the sake of brevity, however, the process of analysis that was found to yield the best results and examples will be described hereinafter.

According embodiment of the present invention, the process involves the following steps:

1. Receiving a trigger from the shocking device indicating that the percussion head had started its descent;

2. Starting recording;

3. Receiving a trigger from the shocking device indicating that the percussion head has hit the silo;

4. Stopping recording;

5. Scanning the recording to locate time indexes. The time indexes are hit/peak time locations and are calculated with the PeakDet algorithm. A vector of length M is created containing the calculated hit locations. M is the number of hits of the percussion head.

6. For each index (i.e., for each percussion) creating a vector of sampling of length of about half a second starting at the index time, which represents the recording of the percussion. At the end of experiment M vectors are obtained, each of length n;

7. For each vector of length n carrying out a Kurtosis calculation:

$$k = \frac{n {\sum }_{i = 1}^{n} {( x - \overline{x} )}^{4}}{{( {\sum }_{i = 1}^{n} {( x - \overline{x} )}^{2} )}^{2}}$$

wherein x̅ is the average of the samples.

$$\overline{x} = \frac{1}{n} {\sum }_{i = 1}^{n} {x}_{i} = \frac{1}{n} ( {x}_{1} + … + {x}_{n} )$$

This obtains a vector K of the Kurtosis values of length M.

8. For vector K, a mean is calculated. A mean of the next p adjacent values calculating the mean of each adjacent p values such as to Create a vector mK of means, having length M−p+1.

For the Kurtosis vector, K, a Moving Average is calculated. The Moving Average can be obtained by first taking the average of the first p elements in vector K. The fixed subset size, p, is then shifted one element forward, creating a new subset of numbers, which is averaged again. This process is repeated over the entire Kurtosis vector K, thus creating a vector mK having length M−p+1.

9. Carrying out a derivative of vector mK such as to create vector dmK having length M−p.

10. Calculating the moving average vector as in 8 above, to obtain vector mdmK having length M−2p+1.

11. Finding the index i of the maximum value of vector mdmK.

12. The index of percussion which indicates a passage from the empty portion of the silo to the full one is i+p.

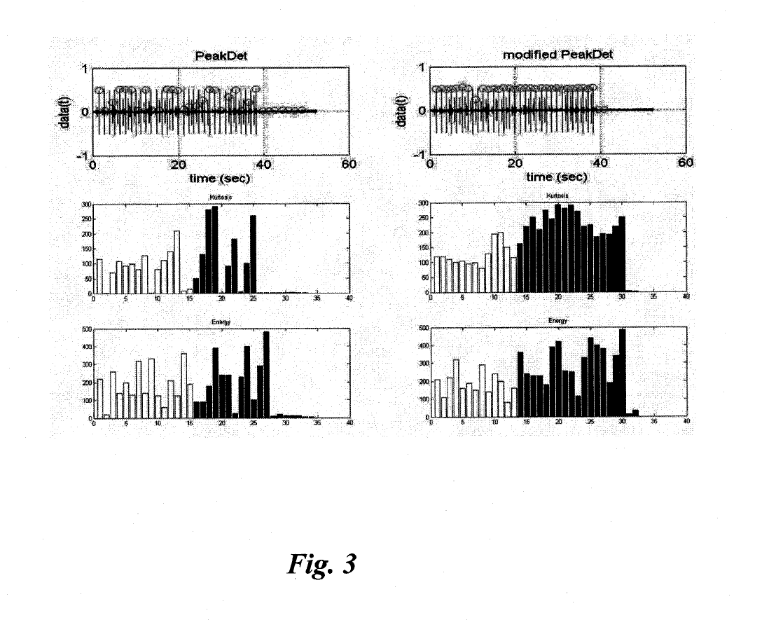

The results of the experiment are shown in the graph of FIG. 3, from which it can be seen that the modified peak detection method yields more extensive data, but that in both cases the Kurtosis algorithm provides better results than the Energy algorithm. This is seen in greater detail in FIG. 5, in which the first 8 percussions in the recording as analyzed according to the above and which were generated by percussion on the empty portion of the silo, stand clearly different from recording 9 and following, which indicates a full vessel. The deviating recording 14, apparently resulting from noise in the recording, shows how difficult it is to differentiate between full and empty portions of the silo, and how the invention provides a solution to this difficulty.

### Development of Silo Hammer Classification Rules Set

The development of rules is done according to the following process:
1. Recoding of data from the hammer module applied to multiple silo types (material, dimensions etc) filled with several types of materials and in a varying weather and environment conditions.
2. Calculation of the parameters (average, standard deviation, coefficient of variance, median, inter-quartile range, integral over the time, minimum value, maximum value, number of times that the signal is crossing the median during a specific time segment) for data recorded during each hammer knocking, and building a data base including the knocking classification (above/below material line) and the calculated parameters, for each time segment for each individual.
3. Applying data mining software for identifying “if and only if” rules for the prediction of knocking classification, based on the calculated parameters of a certain knocking records.
4. Providing a computer program that uses the set of rules to classify the knocking type of each knock record.

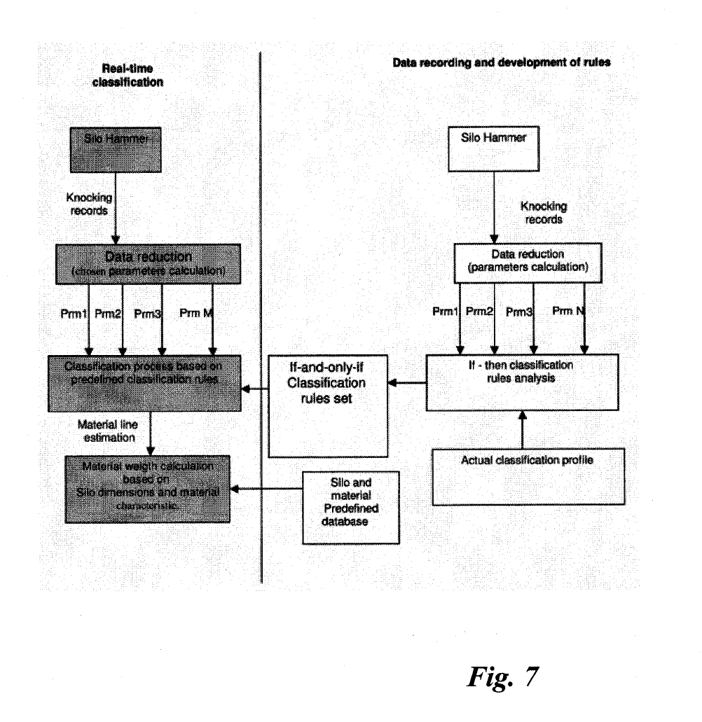

A schematic description of the development of an “if-then” rules set and its use in real time for classification is described in FIG. 7.

### Example 2

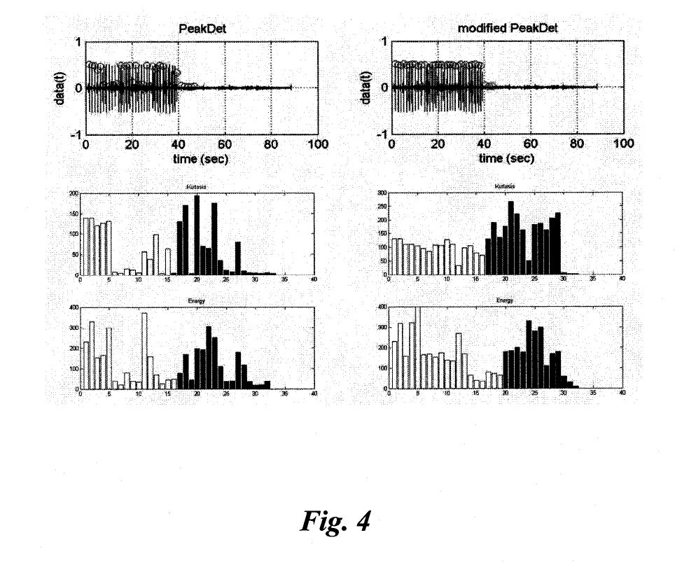

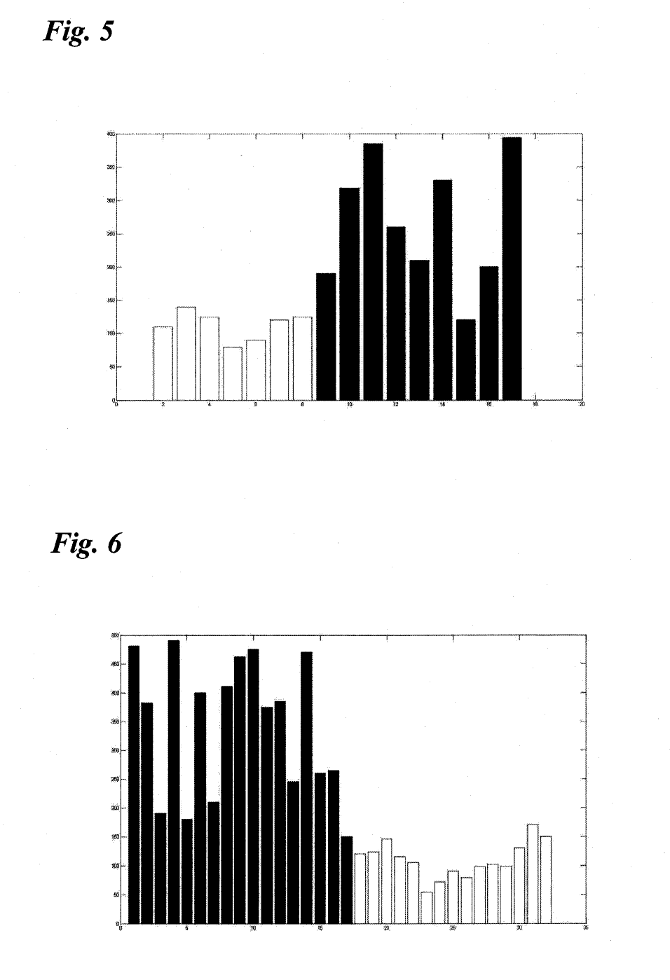

Example 1 was repeated, but this time in the opposite direction, i.e. starting from the full portion of the silo and going up to the empty portion. The results are shown in FIG. 4 and are similar to those obtained in the previous example. A detail of an analysis carried out using the Kurtosis algorithm is shown in FIG. 6, in which the black portions represent the full parts of the silo, and the empty bars portion the empty one.

### Example 3

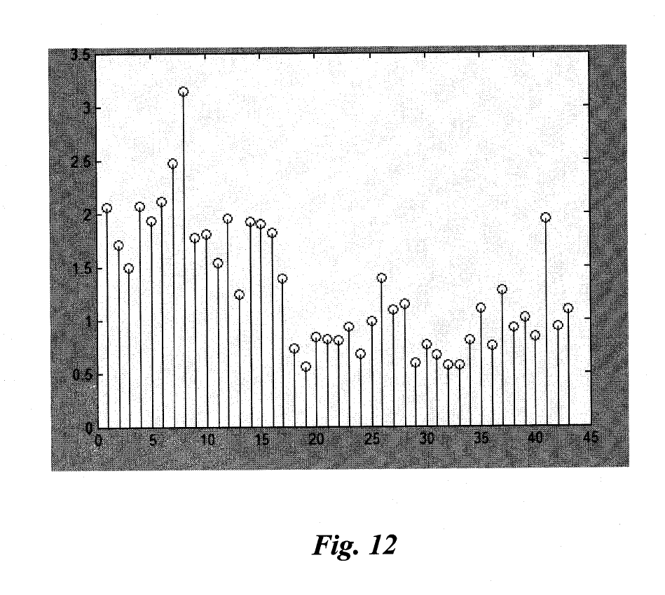

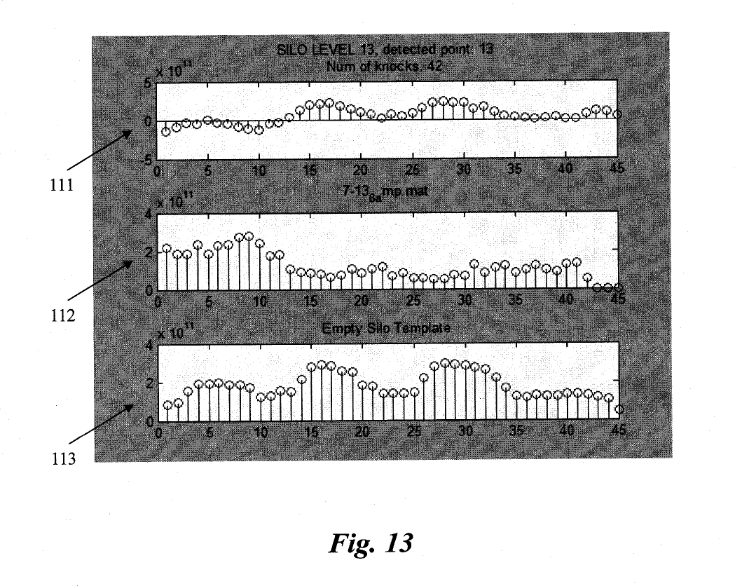

Example 1 was repeated, but this time, another variation of the PeakDet algorithm was employed and for this algorithm to analysis algorithms, calculations of resonance-based algorithm were employed. The results are shown in FIGS. 12-13 and are similar to those obtained in the previous example.

This variation of the peak detection algorithm, denoted as enhanced PeakDet, operates on the recorded raw data that was previously acquired.

The enhanced PeakDet algorithm operates as follows:

The recording (of the raw data) is scanned from start to end, and points M, marked with indices (m) are detected. Detection will take place when point (m) crossed a threshold TH value, and point (m−1) was below the TH value. If a crossing point (m) is detected earlier in time than X sec (e.g., X=0.5), or later than Y sec (e.g., Y=50), it is removed (removal of start and end recording noises). If two crossing points are found within less than Z sec (e.g., 0.5) apart, the second point is removed. At the end of this process M points of indices (m) are detected, according to the number of knocks.

As will be further explained hereinafter the analysis made employing the resonance algorithm optimal results and, therefore, this is an additional preferred method to carry out the invention, although of course less precise results can be obtained using alternative algorithms and, furthermore, algorithms comparable to the following resonance calculations can be employed, all of which is encompassed by the invention. For the sake of brevity, however, the process of analysis that was found to yield this optimal results and examples will be described hereinafter.

According to some embodiments of the present invention, the process involves the following steps:

1. Receiving a trigger from the shocking device indicating that the percussion head had started its descent;

2. Starting recording;

3. Receiving a trigger from the shocking device indicating that the percussion head has hit the silo;

4. Stopping recording;

5. Scanning the recording to locate time indexes. The time indexes are hit/peak time locations and in this embodiment they are calculated with another variation of a PeakDet algorithm. A vector of length M is created containing the calculated hit locations. M is the number of hits of the percussion head.

6. For each index (i.e., for each percussion) creating a vector of sampling of length of about tenth a second (e.g., 0.1 sec) starting at the index time, which represents the recording of the percussion, as shown with respect to FIG. 11. At the end of experiment M vectors are obtained;

7. For each vector V carrying out a resonance calculation:

V_{resonance}=absolute(V); other calculations of V_{resonance} can be carry out, such as V_{resonance}=V̂2, or other calculations that may be derived from the characteristics of the silo.

Find points v, in which TH_{low}<V_{resonance}<TH_{high}, in order to find a range in amplitude that represents the resonance energy, i.e., a range that is above noise level (TH_{low}) and below hit maximal amplitude level (TH_{high}).

Sum up these points, V_{resonance} (v), to a value that represents the resonance per vector V.

After repeating the above calculation M times, for each of the vectors V, a vector K is obtained, containing of the resonance values of each of the M segments. An example of vector K with M=43 is shown with respect to FIG. 12.

8. Vector K is calculated for at least 3 recordings of an empty silo, and a mean vector K is calculated to create a TEMPLATE of reference. If required, the TEMPLATE calculation may be repeated over time in order to obtain better results. This may occur due to changes in the mechanical functionality of the system (such as material fatigue).

9. For each recording of a differing silo capacity height(h), vector K is calculated—Kh.

10. Calculating the point in which the silo changes from empty to full, can be obtained in several calculation methods, for example as described by the following calculation steps:
a. Subtract Kh from TEMPLATE to create an ERR vector;
b. normalize the ERR vector: ERRnorm=ERR/max(ERR);
c. Mark indices in which ERRnorm is larger than a threshold (e.g., 0.1), as vector L;
d. Mark indices in which ERRnorm is smaller than a threshold (e.g., −0.1), as vector S;
e. Find the maximal point in S, which is the last point of the last group of three consecutive indices. Mark it as Slast;
f. Find the first point in vector L, that is larger than Slast and followed by two consecutive indices in vector L. this point is marked as the transformation point from an empty to a full silo, Ltrans;
g. After a point Ltrans is found, calculate the variance for vector Kh from start to Ltrans and from (Ltrans+1) to end:

VAR1=variance(Kh(1:Ltrans))

VAR2=variance(Kh(Ltrans+1:end))
h. If VAR1 is significantly larger than VAR2, keep point Ltrans as algorithm output. Otherwise, go back to steps 13 and 14 and increase gradually the thresholds (both positive and negative towards being more positive) and repeat the process.

FIG. 13 shows the resonance vector K for a specific recording. In this specific recording the silo level in which the silo changed from empty to full is 13.

In this figure, the 3^{rd} subplot (indicated by numeral 113) shows the TEMPLATE, averaged from 11 recordings of an empty silo. The 2^{nd} subplot (indicated by numeral 112) shows vector K calculated for this specific recording. The 1^{st} subplot (indicated by numeral 111) shows the subtraction between them, defined as the ERR.

It is obvious that before point 13 the graph's shape is similar between the TEMPLATE and vector K, as both are recorded from an empty part of the silo. After continuing further, the difference between the patterns is significant, thus creates a large error between them.

The results of the experiment are shown in the graph of FIGS. 12-13, from which it can be seen that the resonance-based algorithm yields more extensive data, and that it provides optimal results. The deviating recording, apparently resulting from noise in the recording, shows how difficult it is to differentiate between full and empty portions of the silo, and how the invention provides a solution to this difficulty by using the above processes.

As will be apparent to the skilled person, by providing cellular capabilities to the device of the invention, important operating information can be generated, which may be of critical importance to owners of silos or containers located at distant locations. Thus, for instance, the system of the invention will be able to provide reports concerning:
daily consumption;
filling state (when a supplier fills the container);
consumption based on different parameters, such as location, type of particulate material, time, etc.

Furthermore, it is possible according to the invention to operate the device from a distance, e.g., to change the frequency of sampling or the sampling distance. All the above provides a control over the contents of the containers, which before the invention was not possible and which is critical in many cases, such as when a silo provides feeding to meat growers.

All the above description and examples have been given for the purpose of illustration and are not intended to limit the invention in any way. Many different mechanisms, methods of analysis, electronic and logical elements can be employed, all without exceeding the scope of the invention.

1. A method for estimating the contents of particulate solids in a solid container, comprising the steps of:
a. providing a percussion device;
b. hitting the surface of the container on it outside with said percussion device at predetermined distances along the height of the container;
c. recording the sound created by said percussion;
d. identifying the sound generated by each recorded percussion at the percussion time within a plurality of percussions;
e. applying an analysis algorithm to a digital representation of the sounds identified in d above; and
f. determining the heights of the container that is filled with particulate material by locating the height at which the value resulting from the analysis of each percussion changes from a high to lower value, wherein a higher value indicates an empty portion of the container, and a lower value indicates a filled portion of the container.

2. A method according to claim 1, wherein the hitting is done by a precise lifting and dropping the percussion device, such that the extent of the impact is constant every time, which makes it possible to effectively analyze the shock wave generated.

3. A method according to claim 1, wherein the estimated contents of a container or of a plurality of containers can be reported in real time (near real time).

4. A method according to claim 1, wherein the identifying of the sound is done by a peak detection algorithm, which operates on the raw data of the recorded sound.

5. A method according to claim 1, wherein the analysis algorithm is a Kurtosis-like algorithm.

6. A method according to claim 1, wherein the analysis algorithm is based on resonance energy calculations.

7. A device for generating an indication of an estimate of the measure of feeling of a container of particulate solids, comprising:
a. a percussion assembly suitable to generate a shockwave by hitting the outer surface of said container at different heights;
b. a sound recorder;
c. an analog to digital device to digitize the sounds recorded by said recorder;
d. logic circuitry to analyze said sounds and to generate an estimate of the height of the particulate material within the container; and
e. cellular module, coupled to said circuitry, which is suitable to transmit a value representative of said estimate to a remote location.
